(19) United States
(12) Patent Application Publication
(10) Pub. No.: US 2026/0302279 A1
(43) Pub. Date: Oct. 1, 2026

(54) HIGH-TEMPERATURE FUEL CELL SYSTEM AND METHOD OF OPERATING IT

(71) Applicant: CELLCENTRIC GMBH & CO. KG, Kirchheim/Teck-Nabern (DE)

(72) Inventor: Michael PROCTER, Burnaby (CA)

(21) Appl. No.: 19/480,610

(22) PCT Filed: May 2, 2024
(86) PCT No.: PCT/EP2024/062070

§ 371 Date: Oct. 31, 2025

(30) Foreign Application Priority Data
May 2, 2023 (DE) 102023204047.6

(51) Int. Cl. H01M 8/04111; H01M 8/04119; H01M 8/0432; H01M 8/0438; H01M 8/04537; H01M 8/04701; H01M 8/04746; H01M 8/04791; H01M 8/04858; H01M 8/10

(52) U.S. Cl. CPC H01M 8/04111; H01M 8/04126; H01M 8/0432; H01M 8/04395; H01M 8/04589; H01M 8/04619; H01M 8/04701; H01M 8/04753; H01M 8/04798; H01M 8/0494; H01M 8/10; H01M 2008/1095; H01M 2250/20

(57) ABSTRACT

Provided is a method of controlling an operation of a PEM fuel cell system, PEMFCS, comprising a set of one or more PEM fuel cells, PEMFC, a compressor with one or more compressor stages for providing a pressurized gaseous oxidizing agent to a cathode side of the PEMFC, and a controller for controlling an operation of the PEMFCS. The method comprises controlling the PEMFCS, by the controller, so as to cause the compressor to compress and provide the gaseous oxidizing agent to a cathode side of the PEMFC during the operation of the PEMFCS as a function of a target electricity output Oₑ of the PEMFCS. Specifically, controlling the PEMFCS comprises controlling at least two of the following parameters: a pressure p to which the oxidizing agent is compressed by the compressor, a flow rate r at which the compressed oxidizing agent is provided to cathode side of the PEMFC, and an operating temperature T of the PEMFC, such that an increase of the operating temperature T is accompanied by at least one of a corresponding increase of the pressure p, and a corresponding decrease of a stoichiometric ratio of the consumption of the oxidizing agent in its electrochemical reaction with a fuel in the PEMFC.

The present invention relates to the field of proton exchange membrane (PEM) fuel cell systems (PEMFCS) comprising one or more PEM-fuel cells (PEMFC). Typical use cases for PEMFCS include mobile applications (e.g., for powering a vehicle such as a truck, bus, or car), and stationary applications (e.g., as local power plant for one or more buildings or an industrial site or a server farm). Specifically, the invention is directed to a method of automatically operating a PEMFCS and to a controller and a PEMFCS being configured to be operated according to such method.

Currently known PEMFCS typically require a relative low operating temperature. PEMFCS are limited in temperature due to two main effects: (i) High temperature reduces oxidizing agent's concentration and reduces thermal efficiency, and (ii) high temperature reduces membrane humidity which reduces thermal efficiency and may cause damage.

Therefore, on the one hand, known PEMFCS lose performance and are at risk of damage as the operating temperature rises above 80° C., particularly in case of PEMFCS for mobile applications. In order to keep a PEMFCS in such temperature range, rather powerful and thus large cooling devices, such as radiators (e.g., in mobile applications) having a sufficient cooling capacity (and thus size) are usually required. However, in a given PEMFCS application, there are typically clear limits as to how far the cooling capacity can be increased. In a vehicle, for example, the available frontal area for placing a radiator as a cooling device for the PEMFCS is naturally limited (even in a large vehicle such as a truck or bus).

On the other hand, there is a need to keep fuel costs for operating PEMFCS low, and therefore reducing its fuel consumption (e.g., average fuel consumption, or fuel consumption per output power) is desirable. Such reduction in fuel consumption could be achieved if the maximum operating temperature of a PEMFCS can be increased without compromising its efficiency and integrity. This is, for example, particularly relevant for high-duty vehicles (HDV), such as long-haul trucks, which must be capable of sustaining high loads at high temperatures, e.g., during summer and in high-temperature and/or mountainous geographic regions.

Conventional approaches for overcoming thermal limitations are to increase the size of the fuel cell and to reduce the area current density. But this goes along with higher space requirements and typically costs for the PEMFCS. Specifically in cargo applications, such increased space requirements may result in a reduction of available cargo capacity in commercial vehicles (and thus increased operating costs).

Accordingly, it is an object of the present invention to define an improved way of expanding the available range of operating temperatures of a PEMFCS, where it can be operated efficiently and without being damaged, towards higher temperatures.

A solution to this problem is provided by the teaching of the independent claims. Various preferred embodiments of the present solution are provided by the teachings of the dependent claims.

A first aspect of the present solution is directed to a method of controlling an operation of a PEM fuel cell system, PEMFCS, the PEMFCS comprising a set of one or more PEM fuel cells, PEMFC, a compressor with one or more compressor stages for providing a pressurized gaseous oxidizing agent, such as oxygen (O₂), to a cathode side of the PEMFC, and a controller for controlling an operation of the PEMFCS. The PEMFC may particularly comprise a stack having a plurality of stacked and interconnected PEM fuel cells.

The method comprises controlling the PEMFCS, by the controller, so as to cause the compressor to compress and provide the gaseous oxidizing agent to a cathode side of the PEMFC during the operation of the PEMFCS as a function of a target electricity output Oₑ of the PEMFCS.

Specifically, controlling the PEMFCS comprises controlling at least two of the following parameters:
(a) a pressure p to which the oxidizing agent is compressed by the compressor,
(b) a flow rate r at which the compressed oxidizing agent is provided to cathode side of the PEMFC, and
(c) an operating temperature T of the PEMFC, such that an increase of the operating temperature T is accompanied by at least one of a corresponding increase of the pressure p, and a corresponding decrease of a stoichiometric ratio λ of the consumption of the oxidizing agent in its chemical reaction with a fuel, such as hydrogen (H₂), in the PEMFC.

The term “operating temperature”, as used herein, may particularly refer to a temperature of a coolant being applied for tempering, particularly cooling, the PEMFC or parts thereof. Alternatively, the operating temperature may particularly be determined as a (non-identity) function of the temperature of the coolant. The operating temperature may particularly be defined as an average, median or maximum temperature occurring in the PEMFC or its coolant during a considered time period of operation of the PEMFCS.

The term “target electricity output”, Oₑ, as used herein, may particularly refer to an electrical output current or to an electrical output power to be supplied by the PEMFCS during its operation.

The term “stoichiometric ratio”, as used herein, refers to the ratio of the actual mass flow rate of a reagent of a chemical reaction to its mass consumption rate in the chemical reaction. In the present case, the term “stoichiometric ratio” particularly refers to the ratio of the actual mass flow rate of the gaseous oxidizing agent to reaction to its mass consumption rate in the chemical reaction with the fuel, e.g., hydrogen (H₂), in the PEMFC.

The terms “first”, “second”, “third” and the like in the description and in the claims, are used for distinguishing between similar elements and not necessarily for describing a sequential or chronological order. It is to be understood that the terms so used are interchangeable under appropriate circumstances and that the embodiments of the present solution described herein are capable of operation in other sequences than described or illustrated herein.

Unless the context requires otherwise, where the term “comprising” or “including” or a variation thereof, such as “comprises” or “comprise” or “include”, is used in the present description and claims, it does not exclude other elements or steps and are to be construed in an open, inclusive sense, that is, as “including but not limited to”.

Where an indefinite or definite article is used when referring to a singular noun e.g., “a” or “an”, “the”, this includes a plural of that noun unless something else is specifically stated.

Appearances of the phrases “in some embodiments”, “in one embodiment” or “in an embodiment”, if any, in the description are not necessarily all referring to the same embodiment. Furthermore, the particular features, structures, or characteristics may be combined in any suitable manner in one or more embodiments.

Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

According to the method, an increase of the operating temperature T, no matter whether it is actively controlled or a mere consequence of given circumstances, such as ambient temperature, or a past or current electrical load of the PEMFCS, is accompanied by a corresponding change of at least one other parameter, namely by a corresponding increase of the (target) pressure p, and/or a corresponding decrease of the (target) stoichiometric ratio λ. In this way, the thermal efficiency of the PEMFCS can be maintained or even improved despite the increase of the operating temperature T, because the change of the pressure p and/or of the stoichiometric ratio λ (and therefore the local mole fraction x) of the oxidizing agent being supplied to the PEMFC are also increased such that the natural negative effect of a mere temperature increase on the concentration of the oxidizing agent is compensated or even reversed.

Specifically, increasing the pressure p also has an adverse effect on water evaporation and thus counteracts at least one of a reduction of membrane humidity, a reduction of thermal efficiency, and humidity-dependent damages to the membrane.

While, absent any countermeasures, increasing the pressure p will naturally require more compressor power and will thus produce more heat, reducing the stoichiometric ratio λ allows for reducing the power requirement of the compressor, so that an increase in the pressure p can be achieved while an associated meaningful increase of the operating temperature T can be mitigated or even completely avoided.

Accordingly, the method provides an improved way of expanding the available range of operating temperatures of a PEMFCS towards higher temperatures without compromising the thermal efficiency and integrity of the PEMFCS, including particularly the integrity of the membrane(s) of the PEMFC.

In the following, preferred embodiments of the method of the first aspect are described, which may be arbitrarily combined with each other or with other aspects of the present solution, unless such combination is explicitly excluded or technically impossible.

In some embodiments, the controlling of the PEMFCS comprises controlling at least two of the parameters as a function of the target electricity output Oₑ such that an increase of the operating temperature T is accompanied by at least one of an increase of the pressure p, and a decrease of the stoichiometric ratio λ so as to increase the ratio (p·x)/T or to maintain it at least within a margin d=±10%, wherein x is the oxidizing agent's molar concentration x of the compressed oxidizing agent, e.g. x=C_{O2} in the case of air. Accordingly, these embodiments are based on using the ratio (p·x)/T, or an equivalent or corresponding quantity, as a control variable for the controller for controlling the operation of the PEMFCS, which allows for an effective and efficient implementation of a controlling scheme to be performed by the controller.

In some embodiments, the controlling of the PEMFCS comprises controlling at least two of the parameters so as to reduce the oxidizing agent's molar concentration x of the compressed oxidizing agent to a minimum oxidizing agent's molar concentration (xₘᵢₙ)which is a function of the target electricity output Oₑ. In this way, the above-identified compensation of the temperature-increasing effect of a pressure increase by a simultaneous decrease of the stoichiometric ratio λ (and hence the oxidizing agent's molar concentration x) can be optimized. Specifically, xₘᵢₙ may be defined as a function of an electrical output current of the PEMFCS or of its associated current density. In the specific embodiments discussed further below with reference to the FIGURES, the oxidizing agent is air, and its molar concentration x will instead be denoted as C_{O2}.

In some embodiments, controlling the PEMFCS comprises controlling all the parameters such that an increase of the operating temperature T is accompanied by a corresponding increase of the pressure p, and a corresponding decrease of the stoichiometric ratio λ. This allows for at least one of a highly effective controlling of the PEMFCS, and an optimized expansion of the operating range of the PEMFCS towards higher operating temperatures, because a maximum number of the parameters are used for mitigating, compensating or even over-compensating adverse effects on thermal efficiency and/or the integrity of the PEMFCS which an increase of the operating temperature of the PEMFCS might otherwise cause.

In some embodiments, at least one of the compressor stages comprises a variable nozzle turbine, VNT, and controlling the pressure p comprises causing an alteration of an effective aspect ratio of the VNT. Thus, the VNT provides an effective and space-efficient means for modifying the pressure p in a controlled manner. The turbine may particularly be a turbine in the exhaust side of an electric turbocharger of the at least one compressor stage.

In some embodiments, controlling of the flow rate r comprises causing an altering of a flow rate of at least one stage of the compressor. Particularly, in the case of a centrifugal compressor stage, controlling the flow rate r may comprise controlling a rotational rate of the compressor stage. Consequently, both the pressure p and the flow rate r may be set by (merely) controlling the operation of the compressor itself.

In some embodiments, controlling the at least two parameters comprises reading a respective setpoint value of each parameter to be controlled from one or more predetermined look-up-tables that collectively define such setpoints as a function of the target electricity output Oₑ or of at least one quantity corresponding thereto. This is particularly useful in cases, where performance (in terms of processing speed) matters and where one or more predefined setpoint functions can be used without compromising the effectiveness and/or efficiency of the method. These one or more setpoint functions, which define respective one or more setpoints as a function of related inputs, such as the target electricity output Oₑ or quantities being derived therefrom, can thus be embodied in the one or more look-up tables, so that the outputs of the setpoint functions are very quickly and reliably available from the one or more look-up tables. Furthermore, look-up tables provide the benefit that even functions, that cannot be (efficiently or at all) defined in a closed manner by a mathematical formula, can nevertheless be easily implemented. This is particularly useful, where the function to be embodied in a look-up table has been derived experimentally by measuring, e.g., a discrete set of a limited number of measurement points, rather than from some sort of mathematical calculation.

In some embodiments, the method further comprises determining the target electricity output Oₑ, wherein determining Oₑ comprises at least one of: (i) measuring Oₑ; (ii) measuring at least one quantity corresponding to Oₑ, and deriving Oₑ based on such measured one or more quantities; (iii) receiving information representing at least one quantity corresponding to Oₑ from an PEMFCS-external source of information and determining Oₑ based on the received information. Thus, in the cases (i) and (ii), the method, or more particularly a PEM fuel cell system implementing the method, becomes largely autonomous, while in case (iii) it can make use of information gathered elsewhere, e.g., by one or more sensors provided elsewhere and potentially even (also) for different purposes in a system or apparatus (e.g., vehicle) powered by the fuel cell system, so that in such a dual-use situation an efficiency increase in terms of saving space and/or costs can be achieved.

In some embodiments, the PEMFCS is applied for powering a vehicle engine and the method is applied to control the PEMFCS during operation of the electric vehicle engine while it is powered, at least in part, by electricity produced by the PEMFCS. This is particularly useful to cover driving situations, where the power demand by the vehicle, including particularly its electric engine, reaches very high level and is accompanied with rather high temperatures. Such a situation might occur, for example, if the vehicle (e.g., a heavy-duty truck with a high load) is driving on a mountainous road at high ambient temperatures, e.g., in a hot desert environment (such as in the Southwest of the USA) or during a hot summer day.

A second aspect of the present solution is directed to a PEM fuel cell system, PEMFCS, comprising: (i) a set of one or more PEM fuel cells, PEMFC, (ii) a compressor with one or more compressor stages for providing a pressurized gaseous oxidizing agent, such as oxygen, to a cathode side of the PEMFC, and (iii) a controller for controlling an operation of the PEMFCS. Herein, the controller is configured to control the PEMFCS according to the method of the first aspect, e.g., according to any one or more of its embodiments described herein.

The PEM fuel may particularly be provided as components of a fuel cell stack in which they are arranged in a stacked manner. A PEM fuel cell stack is a well-known concept for arranging multiple, often several hundred, PEM fuel cells in a very space-efficient manner, e.g., in the field of fuel cells for automotive applications.

The term “controller”, as used herein, refers to any functional unit or set of functional units, which are configured to perform the tasks associated with the controller, particularly to control, in whole or in parts, an operation of the PEMFCS. A controller may particularly comprise on or more physical devices. For example, one or more of these devices may each be implemented as a hardware circuit comprising custom VLSI circuits or gate arrays, off-the-shelf semiconductors such as logic chips, transistors, or other discrete components. A device may also be implemented in programmable hardware means such as field programmable gate arrays, programmable array logic, programmable logic means or the like. A controller may also be implemented, a least in parts, in software for execution by various types of processors. An identified device of executable code may, for instance, comprise one or more physical or logical blocks of computer instructions which may, for instance, be organized as an object, procedure, or function. Nevertheless, the executables of an identified device need not be physically located together but may comprise disparate instructions stored in different locations which, when joined logically together, comprise the device and achieve the stated purpose for the device. Indeed, a device of executable code could be a single instruction, or many instructions, and may even be distributed over several different code segments, among different programs, and across several memory means. Similarly, operational data may be identified and illustrated herein within devices and may be embodied in any suitable form and organized within any suitable type of data structure. The operational data may be collected as a single data set or may be distributed over different locations including over different storage means, and may exist, at least partially, merely as electronic signals on a system or network.

In the following, preferred embodiments of the PEMFCS of the second aspect are described, which may be arbitrarily combined with each other or with other aspects of the present solution, unless such combination is explicitly excluded or technically impossible.

In some embodiments, the PEMFCS further comprises one or more tempering devices (such as one or more radiators or other cooling devices, thermal heat pumps, or heaters) for adjusting a temperature of a coolant flowing through the PEMFC. In this way, the temperature of the PEMFC can be proactively influenced, particularly under the control of the controller, to support bringing or keeping the PEMFC in an optimal operational state or range of operational states. Accordingly, at least one of the tempering devices may be controllable by the controller such as to control said operating temperature of the PEMFC.

In some embodiments, at least one of the compressor stages comprises one or more pressure variation device for altering the pressure p under control of the controller. In this way, the pressure p can be brought or kept at a desired, particularly optimal, pressure level in a controlled manner, particularly as a function of the target electricity output Oₑ, e.g., target output current.

In some embodiments, at least one of the pressure variation devices comprises a pressure control valve. This valve may particularly be arranged in an exhaust channel (e.g., for air) of the PEMFCS. Accordingly, the valve can be used to control the pressure p under the control of the controller.

In some embodiments, at least one of the pressure variation devices comprises a variable nozzle turbine, VNT, an effective aspect ratio of which is controllable by the controller. Specifically, the VNT may be used instead or in combination with the pressure control valve discussed above, to control the pressure p. A VNT is a highly effective pressure control device that is well-controllable, possibly even via a single actuator, using a corresponding control signal provided by the controller.

In some embodiments, at least one of the compressor stages comprises an electric turbocharger being controllable by the controller. This allows for a highly efficient (particularly energy-efficient) pressurizing of the oxidizing agent, e.g., air.

Specifically, in some of these embodiments, the electric turbocharger comprises the VNT. In this way, a very compact and yet highly efficient pressure variation device can be achieved. For example, the VNT may be part of or define a turbine side of the electric turbocharge.

In some embodiments, the PEM fuel cell system further comprises a set of one or more sensors for measuring one or more of the following quantities: (i) the operating temperature T of the PEMFCS (e.g. in terms of a temperature of a coolant for tempering the PEMFC), (ii) a flow rate Q of the oxidizing agent before its compression by the compressor; (iii) an input pressure P of the oxidizing agent before its compression by the compressor, (iv) an electrical current I generated by the PEMFC. Herein, the controller is configured to control the PEMFC based on at least one of these quantities as measured by the set of sensors. These embodiments are particularly useful for implementing the PEMFCS as a largely autonomous system being capable of optimizing the operation of PEMFCS under the control of the controller without the need, or only limited need, for sensor data being generated elsewhere.

In some embodiments, the controller is configured to control a speed of an actuator, e.g., motor, driving at least one of the compressor stages. In this way, as the pressure generated by the respective compressor stage is a function of the speed, the controller can thus control the output pressure of the respective compressor stage.

In some embodiments, the PEMFCS, further comprises a humidifier being configured to humidify the oxidizing agent after its compression by at least one, e.g., all, of the compressor stages. Accordingly, the humidifier may particularly be arranged downstream of the compressor and upstream of the PEMFC. The role of the humidifier is particularly to keep the humidity of the oxidizing agent within a suitable humidity range, because if the humidity is too low, this may cause an increase in the ohmic resistance of the PEMFC and thus to a reduced thermal efficiency.

This is particularly relevant for increasing and high temperatures if the humidifier comprises a gas-to-gas humidity exchanger. Such an exchanger device passes the cathode process air across a gas permeable membrane. Water vapor from the cathode outlet gas is allowed to diffuse across a membrane to humidify the cathode inlet gas. If the temperature increases at such a humidifier, the vapor concentration in the PEMFC outlet gas is typically reduced.

When the temperature gets too high and consequently the humidity of the cathode inlet gas approaches a critical low level, the pressure p must be increased to compensate for this in order to keep the thermal efficiency at a sufficiently high level and prevent damages at the membrane.

A third aspect of the present solution is directed to a controller for controlling an operation of a PEM fuel cell system, PEMFCS, the PEMFCS comprising a set of one or more PEM fuel cells, PEMFC, a compressor with one or more compressor stages for providing a pressurized gaseous oxidizing agent to a cathode side of the PEMFC, wherein the controller is configured to control the PEMFCS according to the method of the first aspect.

A fourth aspect of the present solution is directed to a computer program, particularly a computer program stored or non-transitory computer-readable storage medium, the computer program comprising instructions which when executed on the controller of the PEM fuel cell system of the second aspect cause the controller to perform the method of the first aspect.

The features and advantages explained with respect to the first aspect of the solution apply accordingly to the further aspects of the solution.

The method according to the first aspect is preferably configured to be carried out by the controller according to the second aspect, or the PEMFCS according to the third aspect (particularly by its controller), in particular an embodiment thereof described herein.

The computer program (product) may in particular be implemented in the form of a data carrier on which one or more programs for performing the method are stored. Preferably, this is a data carrier, such as a ROM or flash memory module. This may be advantageous, if the computer program product is meant to be traded as an individual product independent from the processor platform on which the one or more programs are to be executed. In another implementation, the computer program product is provided as a file on a data processing unit, in particular on a server, and can be downloaded via a data connection, e.g., the Internet or a dedicated data connection, such as a proprietary or local area network. The controller of the second aspect and/or the PEMFCS of the third aspect may accordingly each have a program memory in which the computer program is stored. Alternatively, the system may also be set up to access a computer program available externally, for example in one or more external storages or on one or more servers or other data processing units, via a communication link, in particular to exchange with it data used during the course of the execution of the computer program or representing outputs of the computer program.

### BRIEF DESCRIPTION OF THE DRAWINGS

Further advantages, features and applications of the present solution are provided in the following detailed description and the appended FIGURES, wherein:

FIG. 1A shows a block diagram illustrating an exemplary embodiment of the method of the first aspect;

FIGS. 1B, 1C and 1D shows exemplary embodiments of setpoint maps for three of the setpoints defined in the method of FIG. 1A;

FIG. 2 is a block diagram illustrating a first embodiment of the PEMFCS;

FIG. 3 is a block diagram illustrating a second embodiment of the PEMFCS; and

FIG. 4; is a block diagram illustrating a third embodiment of the PEMFCS.

In the FIGURES, identical reference signs are used for the same or mutually corresponding elements of the method and PEMFCS described herein.

### DETAILED DESCRIPTION OF EMBODIMENTS

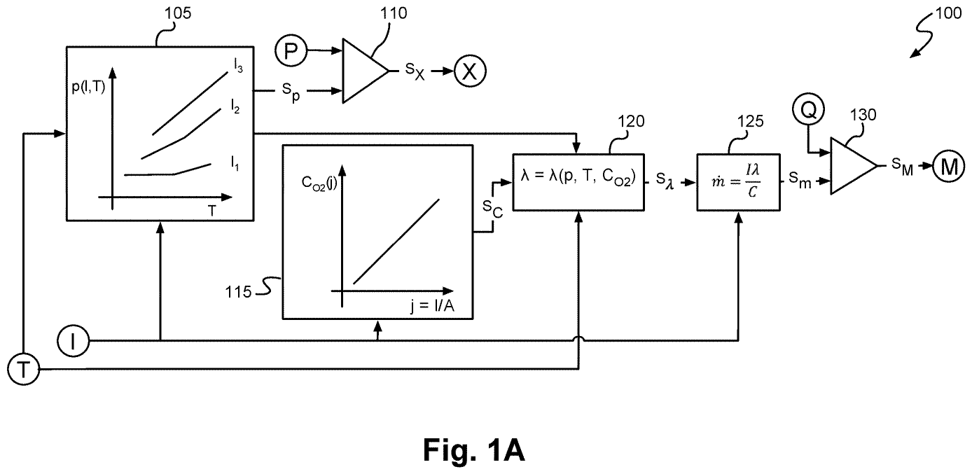

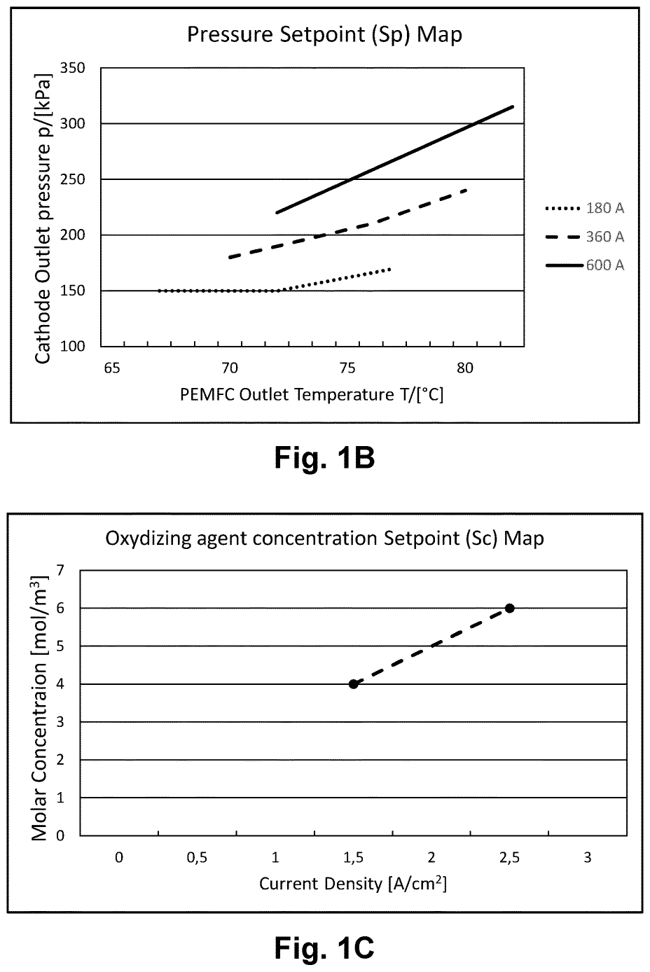

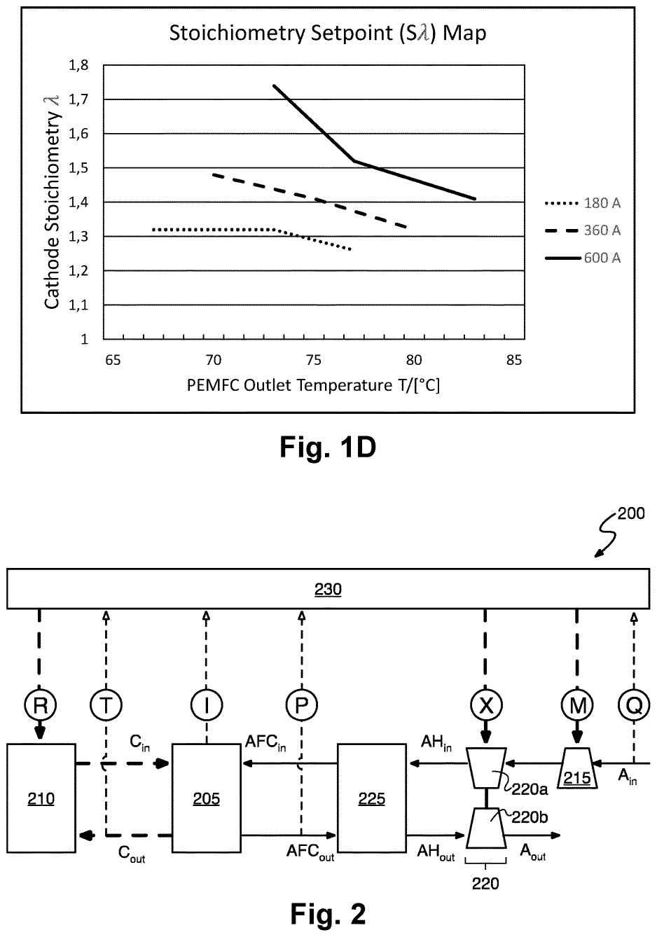

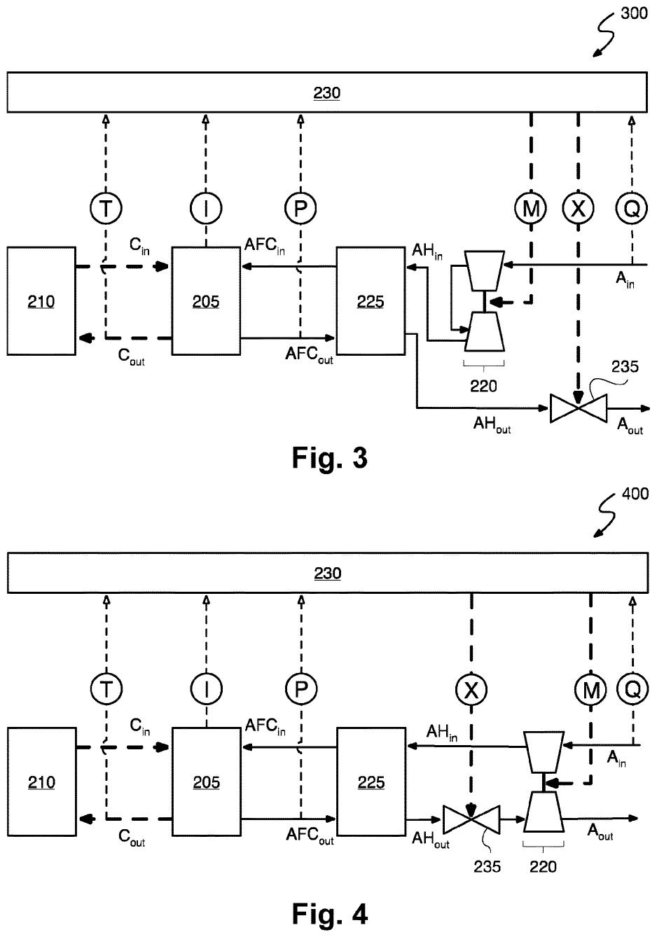

FIG. 1A shows a block diagram illustrating an exemplary embodiment of a method 100 of controlling an operation of a PEM fuel cell system, PEMFCS. Various embodiments of such a PEMFCS are illustrated in FIGS. 2, 3 and 4. While in the following, the method 100 will be discussed with reference to FIG. 1A through FIG. 1D in combination with the PEMFCS 200 illustrated in FIG. 2, any of the other embodiments of the PEMFCS provided herein, e.g., any of the embodiments in FIGS. 3 and 4 might be referenced instead that of FIG. 2. Referring first to FIG. 2, the PEMFCS 200 illustrated therein comprises a set (PEMFC) 205, e.g., fuel cell stack, comprising one or more PEM fuel cells, a compressor with a (typically electrical) first compressor stage 215 and a second compressor stage 220. The compressor is configured to receive at its inlet a supply Aᵢₙ of a gaseous oxidizing agent, such as air, and to generate and provide at its outlet a pressurized stream AHᵢₙ of the oxidizing agent to a cathode side of the PEMFC 205. In the present example, the second compressor stage 220 comprises an electric turbo charger with a compressor wheel 220a and a turbine 220b. The turbo charger is of the variable nozzle turbine (VNT) type so that an effective aspect ratio of its turbine 220b can be altered. Accordingly, stages 215 and 220 in combination form a 2-stage electric turbo charger (ETC) of the VNT type. PEMFCS 200 further comprises a controller 230 for controlling an operation of the PEMFCS 200. Such control comprises particularly controlling via respective one or more actuators the effective aspect ratio of the VNT turbine 220b and a rotational speed of at least the first stage 215 (and optionally also the second stage 220). Specifically, a control signal X may be used to control the effective aspect ratio of the VNT turbine 220b and another control signal M may be used to control the respective speed(s) of the compressor stage(s). In addition, a flow rate sensor may be provided for measuring a flow rate Q of the incoming stream Aᵢₙ of gaseous oxidizing agent at the supply side of the PEMFCS 200.

Moreover, PEMFCS 200 further comprises a tempering device 210 (or is alternatively connected to a PEMFCS-external tempering device). For example, particularly in the case of a PEMFCS for an automotive application (such as powering a truck), the tempering device 210 may comprise a radiator (e.g., the main radiator of the truck). A coolant is circulated through the PEMFC 205, particularly through each of its fuel cells in suitable channels, and through the tempering device. Particularly, during operation of PEMFCS 200, stream Cᵢₙ of cool coolant is flowing from the tempering device 210 (in this case: cooling device, e.g., radiator) to the PEMFC 205 where it absorbs heat being generated in the fuel cells, and then returns to the tempering device 210 in a return stream Cₒᵤₜ, thus transporting heat from the PEMFC 205 to the tempering device 210 for cooling.

A temperature sensor for measuring a temperature T of the PEMFC 205 is provided in thermal contact with the coolant, for example in thermal contact with stream Cᵢₙ. In the latter case, the temperature T corresponds to a temperature at an outlet side of the PEMFC 205.

The PEMFC 205 comprises a fuel inlet (not shown) for receiving a fuel, such as molecular hydrogen (H₂), an providing it to the anode side of the fuel cells of the PEMFC 205. Furthermore, PEMFC 205 comprises a further inlet for receiving a stream AFCᵢₙ of gaseous oxidizing agent, such as air or a gas comprising a higher percentage of oxygen (O₂). Within the fuel cells, the fuel is chemically reacted with the oxidizing agent to produce electrical energy. If the PEMFC 205 is connected to an electrical circuit, e.g., to an electrical engine, an electrical current I produced by the PEMFC 205 can flow and be measured by a suitable sensor, e.g., an amperemeter.

At an outlet of the cathode side PEMFC 205, a return stream AFCₒᵤₜ of the (non-consumed) gaseous oxidizing agent can leave the PEMFC 205, and a suitable pressure sensor is provided to measure a pressure P of the return stream AFCₒᵤₜ.

PEMFCS 200 may further comprise a humidifier 225. Particularly, as illustrated, it may be arranged such that both gas streams AFCᵢₙ and AFCₒᵤₜ pass through it. While humidifier 225 humidifies the ingoing gas stream AHᵢₙ coming from the compressor in order to ensure, via the humidified gas stream AFCᵢₙ, a sufficiently high humidity of the membranes of the PEM fuel cells, it dehumidifies the outgoing gas stream AFCₒᵤₜ in order to capture moisture to be used again at the ingoing side for humidifying gas stream AFCᵢₙ. Specifically, the humidity of the gas stream AFCₒᵤₜ at the outlet of the cathode side of PEMFC 205 may be targeted at a relative humidity (RH) that is close to 100%. The range may particularly vary from RH: 80% . . . 120%. The dehumidified outgoing gas stream AHₒᵤₜ is targeted at a much lower RH in order to have a high effectiveness of the humidifier 225 and to keep the humidity of the gas stream AHₒᵤₜ when it reaches and drives the turbine 220b and is finally exhausted as exhaust stream Aₒᵤₜ low enough to mitigate condensation.

Optionally, the tempering device 210 may have a variable tempering capability, such as a variable cooling capacity being controllable via a control signal R by the controller 230. In this way, the temperature T may be affected, via the control signal R. For example, if the measure value of T increases and approaches or even reaches a level defining an upper temperature limit of an operating range of the PEMFC 205, the control signal R can be used to increase the cooling capacity of the tempering device 210 so as to keep T below the temperature limit.

All measurements made by the various sensors are provided to controller 230 in the form of respective sensor data, and the controller 230 is configured, e.g., by means of one or more suitable computer programs, to process the sensor data to derive therefrom control signals for controlling an operation of PEMFCS 200. Specifically, such control signals comprise control signal X and control signal M to control the operation of the 2-stage VNT-type turbo charger.

Referring now again to FIG. 1A, the method 100 of controlling the PEMFCS 200 will be explained in more detail. The method comprises receiving various inputs, including particularly the measured current or at least most recent values of the temperature T, the pressure P, and the flow rate Q.

A further input is a target electricity output Oₑ. In the present example, the target electricity output Oₑ is a target electrical output current I to be provided by the PEMFCS 200, such as the current requested via the throttle control by a driver of a vehicle powered by the PEMFCS 200. Alternatively, the target electricity output Oₑ may be set equal to a current, as measured, that the PEMFC 205 can currently provide at the given flow Q. The controller 230 processes all of these inputs to derive therefrom control signals for controlling the PEMFCS 200 so as to cause it to approach and (if possible) achieve the target electricity output Oₑ. Specifically, the supply rate of the fuel at the anode side could be controlled to the purpose. Furthermore, as will be explained in more detail below, via the control signals X and M, to that purpose, the controller 230 also controls a molar concentration and a supply rate (flow rate) of the oxidizing agent at the cathode side of the PEMFC 205.

The processing to be performed by the controller 230 comprises calculating several setpoints.

Specifically, a first process 105 comprises determining a target pressure p of the gaseous oxidizing agent as a function p(I,T) of the input quantities I and T. The determined target pressure p defines a first setpoint Sₚ and may particularly relate to the pressure in outgoing stream AFCₒᵤₜ, where also the actual pressure P is being measured. A comparison 110 (e.g., by a comparator device in the controller 230) between the setpoint Sₚ and the measured value P is performed to derive therefrom a further setpoint, namely a setpoint Sₓ for affecting the actual pressure, in the present example via controlling the effective aspect ratio of the turbine 220b of the VNT-type ETC. The control signal X may thus be defined to be equal or otherwise corresponding to the determined setpoint Sₓ, so that applying the control signal X to the actuator(s) affecting the effective aspect ratio of the turbine 220b results in reaching an actual effective aspect ratio as determined by the setpoint Sₓ.

FIG. 1B shows an exemplary pressure setpoint map for determining the target pressure p as a function of the temperature T and for three different values of current I for an exemplary fuel cell design. Accordingly, cathode outlet pressure values p (and similarly P) may particularly have the following characteristics: Cathode outlet pressure is higher than 100 kPa and lower than 350 kPa. Cathode outlet pressure is constant or increases with temperature T and current I. Cathode pressure variation with temperature T is not directly proportional to changes in gas density.

Referring again to FIG. 1A, a further process 115 comprises determining a target molar concentration C_{O2} of the gaseous oxidizing agent (in the present example a concentration of O₂ in air) as a function C_{O2} G) of the current density j=I/A relating to input quantity I and the relevant area A of the current path for I. The determined target molar concentration C_{O2} defines another setpoint S_{C} and may particularly relate to the molar concentration C_{O2} in outgoing stream AFCₒᵤₜ at the outlet of the cathode side.

FIG. 1C shows an exemplary molar concentration setpoint map for determining the target molar concentration C_{O2}(j) for an exemplary fuel cell design. C_{O2}(j) may particularly have the following characteristics: C_{O2}(j) is, at least substantially, proportional to current density j for regions of the operating range where the cathode channel Reynold Number Re is greater than 80 (Re>80) and/or the current density j>0.5 A/cm². The slope may particularly range from 2 to 4 mol m⁻³ cm²A⁻¹.

Referring again to FIG. 1A, a further process 120 comprises determining a target stoichiometric ratio λ of the consumption of the oxidizing agent in its electrochemical reaction with a fuel in the PEMFC 205. The stoichiometric target ratio λ is determined as a function λ(p, T, C_{O2}), i.e., as a function of the target pressure p, the temperature T, and the molar concentration C_{O2}(j) determined by process 115. Specifically, λ may be calculated using the molar gas constant R and a fitting parameter K for MEA water crossover as follows:

$$λ = \frac{( 2 K - 1 ) {C}_{O 2} R T + P}{( P - {C}_{O 2} R T ( 4.76 + \frac{K {ω}_{i n}}{0.21} ) )}$$

$${ω}_{i n} = \frac{{η}_{humidifier} RH \cdot {P}_{sat} ( T )}{P - {η}_{humidifier} RH \cdot {P}_{sat} ( T )}$$

The output of process 120 thus defines yet another setpoint S_{λ}=λ and may particularly relate to the stoichiometric ratio in ingoing streams AHᵢₙ or AFCᵢₙ at the inlet of the cathode side.

FIG. 1D shows an exemplary stoichiometric ratio setpoint map for determining the target stoichiometric ratio Sₓ=λ as a function of T and for three different values of current I. Cathode stoichiometry values A may particularly have the following characteristics: λ is greater than 1 and it reduces with increasing pressure and with increasing temperature. It increases with current I for a given temperature T.

Referring again to FIG. 1A, a yet further process 125 comprises determining a target flow rate

$$r = \dot{m} = \frac{dm}{dt} = \frac{I}{4 F} \frac{{M}_{air}}{0.21} {N}_{c e l l s} λ ,$$

wherein F is Faraday's constant, Mₐᵢᵣ is the molar mass of air, and N_{cells} is the number of cells in the fuel cell stack.

The determined target flow rate r, specially defined here as mass flow rate \dot{m}, defines yet another setpoint Sₘ and may particularly relate to a flow rate in ingoing stream AHᵢₙ at the outlet of the compressor stage 220.

Referring again to FIG. 1A, a further process 130 comprises determining yet another setpoint S_{M}, namely a target flow rate of the gaseous oxidizing agent at the compressor outlet as a function S_{M}(Q, Sₘ) of the measured flow rate Q and the determined setpoint Sₘ. Process 130 comprises a comparison (e.g., by a comparator device in the controller 230) between the setpoint Sₘ and the measured value Q to derive therefrom setpoint S_{M}. The control signal M may thus be defined to be equal or otherwise corresponding to the determined setpoint S_{M}, so that applying the control signal M to the actuator(s) (e.g., electric drive(s) of the compressor) results in reaching an actual flow rate in the stream AHᵢₙ at the compressor outlet as determined by the setpoint SM.

Accordingly, controlling the PEMFCS 200 using method 100 comprises controlling at least two of the following parameters:
(a) the pressure p to which the oxidizing agent is compressed by the compressor 215/220,
(b) a flow rate r (e.g., mass flow rate at which the compressed oxidizing agent is provided to cathode side of the PEMFC 205), and
(c) an operating temperature T of the PEMFC 205,
   such that an increase of the operating temperature T is accompanied by at least one of a corresponding increase of the pressure p, and a corresponding decrease of a stoichiometric ratio λ of the consumption of the oxidizing agent in its electrochemical reaction with a fuel, such as hydrogen (H₂), in the PEMFC 205.

FIG. 3 is a block diagram illustrating a second embodiment 300 of the PEMFCS. While it has large similarities with the first embodiment 200 (which will therefore not be discussed here again), there are the following differences: The compressor 220 comprises an electric turbo charger (ETC) that is configured such that its compressor wheel 220a acts as a first compressor stage and downstream of it the turbine 220b acts as a second compressor stage (instead of its normal role as a turbo turbine in the exhaust channel). The speed of the compressor 220 is controlled by the controller via control signal M. In addition, a pressure control valve 235 is arranged in the outgoing stream (exhaust channel) and configured to be controlled by the controller 230 via control signal X so as to vary the actual pressure P toward the target pressure p.

FIG. 4 is a block diagram illustrating a third embodiment 400 of the PEMFCS. While it also has large similarities with the first embodiment 200 (which will therefore not be discussed here again), there are the following differences: The compressor 220 comprises an electric turbo charger (ETC) that is configured such that its compressor wheel 220a acts as a first compressor stage and the turbine 220b acts in its normal role as a turbo turbine in the exhaust channel. The speed of the compressor 220 is controlled by the controller via control signal M. In addition, a pressure control valve 235 is arranged in the outgoing stream (exhaust channel) between the humidifier 225 and the turbine 220b and configured to be controlled by the controller 230 via control signal X so as to vary the actual pressure P toward the target pressure p.

While above at least one exemplary embodiment of the present solution has been described, it has to be noted that a great number of variations thereto exist. Furthermore, it is appreciated that the described exemplary embodiments only illustrate non-limiting examples of how the present solution can be implemented and that it is not intended to limit the scope, the application or the configuration of the herein-described apparatuses and methods. Rather, the preceding description will provide the person skilled in the art with constructions for implementing at least one exemplary embodiment of the present solution, wherein it must be understood that various changes of functionality and the arrangement of the elements of the exemplary embodiment can be made, without deviating from the subject-matter defined by the appended claims.

### LIST OF REFERENCE SIGNS

100 Method of controlling an operation of a PEMFCS
105 process for determining a target pressure setpoint
110 process for determining a setpoint for an actuator affecting the actual pressure
115 process for determining a target molar concentration setpoint
120 process for determining a target stoichiometric ratio
125 process for determining a target flow rate
130 process for determining a setpoint for an actuator affecting the actual flow rate
200 first embodiment of PEMFCS
205 set of PEM fuel cells, PEMFC
210 tempering device, e.g., radiator
215 first compressor stage
220 electric turbo charger, ETC, particularly as second compressor stage
220a compressor wheel
220b turbine, e.g. VNT
225 humidifier
230 controller
235 pressure control valve
300 second embodiment of PEMFCS
400 third embodiment of PEMFCS
A effective cross-section for determining current density j from I
Aᵢₙ stream of oxidizing agent from its inlet to compressor
Aₒᵤₜ stream of oxidizing agent (in exhaust channel) out of the PEMFCS
AFCᵢₙ stream of oxidizing agent from humidifier to PEMFC
AFCₒᵤₜ stream of oxidizing agent from PEMFC to humidifier
AHₒᵤₜ stream of oxidizing agent from compressor to humidifier
AHₒᵤₜ stream of oxidizing agent from humidifier towards exhaust channel
C constant in formula for stoichiometric ratio A
Cᵢₙ coolant stream from tempering device to PEMFC
Cₒᵤₜ coolant stream from PEMFC to tempering device
C_{O2} molar concentration of oxidizing agent
η_{humidifier} humidifier vapor exchange efficiency
F Faraday's Constant, F=96495 C/mol
I target current (or measured currently possible current)
I₁, . . . , I₃ current values
j current density corresponding to current I
K fitting parameter for MEA water crossover
λ stoichiometric ratio
\dot{m} mass flow rate
M control signal for an actuator affecting the actual flow rate
N_{cells} number of cells in the fuel cell stack
P measured pressure
p target pressure
Pₛₐₜ vapor saturation pressure
Q measured flow rate of oxidizing agent upstream of compressor
r flow rate
Sₚ setpoint for target pressure p
S_{X} setpoint for actuator affecting the actual pressure
S_{C} setpoint for molecular concentration
S_{λ} setpoint for stoichiometric ratio
Sₘ setpoint for mass flow rate
S_{M} setpoint for actuator affecting the actual flow rate
T measured temperature
ωᵢₙ humidity ratio at the fuel cell inlet
X control signal for an actuator affecting the actual pressure

What is claimed is:

1. A method controlling an operation of a PEM fuel cell system, PEMFCS, the PEMFCS, the PEMFCS comprising a set of one or more PEM fuel cells, PEMFC, a compressor with one or more compressor stages for providing a pressurized gaseous oxidizing agent to a cathode side of the PEMFC, and a controller for controlling an operation of the PEMFCS, the method comprising:
controlling the PEMFCS, by the controller, so as to cause the compressor to compress and provide the gaseous oxidizing agent to a cathode side of the PEMFC during the operation of the PEMFCS as a function of a target electricity output Oₑ of the PEMFCS, wherein controlling the PEMFCS comprises controlling at least two of the following parameters:
(a) a pressure p to which the oxidizing agent is compressed by the compressor,
(b) a flow rate r at which the compressed oxidizing agent is provided to cathode side of the PEMFC, and
(c) an operating temperature T of the PEMFC,
such that an increase of the operating temperature T is accompanied by at least one of a corresponding increase of the pressure p, and a corresponding decrease of a stoichiometric ratio λ of the consumption of the oxidizing agent in its electrochemical reaction with a fuel in the PEMFC.

2. The method of claim 1, wherein the controlling of the PEMFCS comprises controlling at least two of the parameters as a function of the target electricity output Oₑ such that an increase of the operating temperature T is accompanied by at least one of an increase of the pressure p, and a decrease of the stoichiometric ratio λ so as to increase the ratio (p·x)/T or to maintain it at least within a margin M=±10%, wherein x is the oxidizing agent's molar concentration x of the compressed oxidizing agent.

3. The method of claim 1,
wherein the controlling of the PEMFCS comprises controlling at least two of the parameters so as to reduce the oxidizing agent's molar concentration x of the compressed oxidizing agent to a minimum oxidizing agent's molar concentration being a function of the target electricity output Oₑ.

4. The method of claim 1,
wherein controlling the PEMFCS comprises controlling all of the parameters such that an increase of the operating temperature T is accompanied by a corresponding increase of the pressure p, and a corresponding decrease of the stoichiometric ratio λ.

5. The method of claim 1,
wherein at least one of the compressor stages comprises a variable nozzle turbine, VNT, and controlling the pressure p comprises causing an alteration of an effective aspect ratio of the VNT.

6. The method of claim 1,
wherein controlling of the flow rate r comprises causing an altering of a flow rate of at least one stage of the compressor.

7. The method of claim 1,
wherein controlling the at least two parameters comprises reading a respective setpoint value of each parameter to be controlled from one or more predetermined look-up-tables that collectively define such setpoints as a function of the target electricity output Oₑ or of at least one quantity corresponding thereto.

8. The method of claim 1,
further comprising determining the target electricity output Oₑ, wherein determining Oₑ comprises at least one of:
measuring Oₑ;
measuring at least one quantity corresponding to Oₑ, and deriving Oₑ based on such measured one or more quantities;
receiving information representing at least one quantity corresponding to Oₑ from an PEMFCS-external source of information and determining Oₑ based on the received information.

9. The method of claim 1,
wherein the PEMFCS is applied for powering an electric vehicle engine and the method is applied to control the PEMFCS during operation of the electric vehicle engine while it is powered, at least in part, by electricity produced by the PEMFCS.

10. A controller for controlling an operation of a PEM fuel cell system, PEMFCS, the PEMFCS comprising a set of one or more PEM fuel cells, PEMFC, a compressor with one or more compressor stages for providing a pressurized gaseous oxidizing agent to a cathode side of the PEMFC, wherein the controller is configured to control the PEMFCS according to the method of claim 1.

11. A PEM fuel cell system, PEMFCS, comprising:
a set of one or more PEM fuel cells, PEMFC,
a compressor with one or more compressor stages for providing a pressurized gaseous oxidizing agent to a cathode side of the PEMFC, and
a controller for controlling an operation of the PEMFCS;
wherein the controller is configured to control the PEMFCS according to the method of claim 1.

12. The PEM fuel cell system of claim 11, further comprising one or more tempering devices for adjusting a temperature of a coolant flowing through the PEMFC.

13. The PEM fuel cell system of claim 12, wherein at least one of the tempering devices is controllable by the controller such as to control said operating temperature of the PEMFC.

14. The PEM fuel cell system of claim 11, wherein one or more of the compressor stages comprises at least one pressure variation device for altering the pressure p under control of the controller.

15. The PEM fuel cell system of claim 14, wherein at least one of the pressure variation devices comprises a pressure control valve.

16. The PEM fuel cell system of claim 14, wherein at least one of the pressure variation devices comprises a variable nozzle turbine, VNT, an effective aspect ratio of which is controllable by the controller.

17. The PEM fuel cell system of claim 11, wherein at least one of the compressor stages comprises an electric turbocharger being controllable by the controller.

18. The PEM fuel cell system of claim 16, wherein the electric turbocharger comprises the VNT.

19. The PEM fuel cell system of claim 11, further comprising a set of one or more sensors for measuring one or more of the following quantities:
the operating temperature T of the PEMFCS,
a flow rate Q of the oxidizing agent before its compression by the compressor;
an input pressure P of the oxidizing agent before its compression by the compressor,
an electrical current generated by the PEMFC;
wherein the controller is configured to control the PEMFC based on at least one of these quantities as measured by the set of sensors.

20. The PEM fuel cell system of claim 11, wherein the controller is configured to control a speed of an actuator driving at least one of the compressor stages.

21. The PEM fuel cell system of claim 11, further comprising a humidifier being configured to humidify the oxidizing agent after its compression by at least one of the compressor stages.

22. A computer program, particularly a computer program stored or non-transitory computer-readable storage medium, the computer program comprising instructions which when executed on the controller of the PEM fuel cell system, PEMFCS, of claim 11, cause the controller to perform the method comprising: controlling the PEMFCS to cause the compressor to compress and provide the gaseous oxidizing agent to a cathode side of the PEMFC during the operation of the PEMFCS as a function of a target electricity output Oₑ of the PEMFCS, wherein controlling the PEMFCS comprises controlling at least two of the following parameters: (a) a pressure p to which the oxidizing agent is compressed by the compressor, (b) a flow rate r at which the compressed oxidizing agent is provided to cathode side of the PEMFC, and (c) an operating temperature T of the PEMFC, such that an increase of the operating temperature T is accompanied by at least one of a corresponding increase of the pressure p, and a corresponding decrease of a stoichiometric ratio λ of the consumption of the oxidizing agent in its electrochemical reaction with a fuel in the PEMFC.
